(19) United States
(12) Patent Application Publication
(10) Pub. No.: US 2026/0290385 A1
(43) Pub. Date: Sep. 24, 2026

(54) MAGNETIC HEAD AND MAGNETIC RECORDING DEVICE

(71) Applicants: Kabushiki Kaisha Toshiba, Kawasaki-shi (JP); Toshiba Electronic Devices & Storage Corporation, Kawasaki-shi (JP)

(72) Inventors: Yuji NAKAGAWA, Kawasaki Kanagawa (JP); Tazumi NAGASAWA, Yokohama Kanagawa (JP); Tomoyuki MAEDA, Kawasaki Kanagawa (JP)

(21) Appl. No.: 19/532,587

(22) Filed: Feb. 6, 2026

(30) Foreign Application Priority Data
Mar. 19, 2025 (JP) 2025-044211

(51) Int. Cl. G11B 5/31; G11B 5/008

(52) U.S. Cl. CPC G11B 5/315; G11B 5/008

(57) ABSTRACT

According to one embodiment, a magnetic head includes a reproducing section. The reproducing section includes first to fourth shields, and a stacked body. At least a part of the stacked body is provided between the first shield and the second shield and between the third shield and the fourth shield. The stacked body includes a first magnetic layer, a second magnetic layer between the first magnetic layer and the second shield in the first direction, a third magnetic layer between the first shield and the first magnetic layer in the first direction, a fourth magnetic layer overlapping at least a part of the third magnetic layer in the first direction, a first intermediate layer between the first magnetic layer and the second magnetic layer, and a second intermediate layer between the second magnetic layer and the second shield. The fourth magnetic layer includes Mn.

### CROSS-REFERENCE TO RELATED APPLICATIONS

This application is based upon and claims the benefit of priority from Japanese Patent Application No.2025-044211, filed on Mar. 19, 2025; the entire contents of which are incorporated herein by reference.

### FIELD

Embodiments described herein relate generally to a magnetic head and a magnetic recording device.

### BACKGROUND

A magnetic head including a magnetic sensor using a magnetic layer is used to record information on a magnetic recording medium such as an HDD (Hard Disk Drive). Improved characteristics of the magnetic head are desired.

### BRIEF DESCRIPTION OF THE DRAWINGS

FIGS. 1A and 1B are schematic views illustrating a magnetic head according to a first embodiment;

FIG. 2 is a schematic plan view illustrating the magnetic head according to the first embodiment;

FIG. 3 is a schematic diagram illustrating the characteristics of the magnetic head according to the first embodiment;

FIG. 4 is a graph illustrating the characteristics of the magnetic head according to the first embodiment;

FIG. 5 is a graph illustrating the characteristics of the magnetic head according to the first embodiment;

FIGS. 6A and 6B are schematic cross-sectional views illustrating a part of magnetic heads according to the first embodiment;

FIGS. 7A to 7C are schematic cross-sectional views illustrating a part of magnetic heads according to the first embodiment;

FIGS. 8A and 8B are schematic diagrams illustrating a magnetic head according to the first embodiment;

FIGS. 9A and 9B are schematic diagrams illustrating a magnetic head according to a second embodiment;

FIG. 10 is a schematic plan view illustrating the magnetic head according to the second embodiment;

FIGS. 11A and 11B are schematic diagrams illustrating the characteristics of the magnetic head according to the first embodiment;

FIG. 12 is a schematic perspective view illustrating the magnetic head and magnetic recording device according to the embodiment;

FIG. 13 is a schematic perspective view illustrating a part of the magnetic recording device according to the embodiment;

FIG. 14 is a schematic perspective view illustrating the magnetic recording device according to the embodiment; and

FIGS. 15A and 15B are schematic perspective views illustrating a part of the magnetic recording device according to the embodiment.

### DETAILED DESCRIPTION

According to one embodiment, a magnetic head includes a reproducing section. The reproducing section includes a first shield, a second shield, a third shield, a fourth shield, and a stacked body. The third shield and the fourth shield are between the first shield and the second shield. A second direction from the third shield to the fourth shield crosses a first direction from the first shield to the second shield. At least a part of the stacked body is provided between the first shield and the second shield and between the third shield and the fourth shield. The stacked body includes a first magnetic layer, a second magnetic layer between the first magnetic layer and the second shield in the first direction, a third magnetic layer between the first shield and the first magnetic layer in the first direction, a fourth magnetic layer overlapping at least a part of the third magnetic layer in the first direction, a first intermediate layer between the first magnetic layer and the second magnetic layer, and a second intermediate layer between the second magnetic layer and the second shield. The fourth magnetic layer includes Mn. The first intermediate layer includes at least one selected from the group consisting of Ru, Ir, Os, Re and Rh. A first intermediate layer thickness in the first direction of the first intermediate layer is not less than 0.3 nm and not more than 0.5 nm, or not less than 0.7 nm and less than 1.0 nm. The second intermediate layer is non-magnetic and conductive. The second intermediate layer is in contact with the second magnetic layer and the second shield.

Various embodiments are described below with reference to the accompanying drawings.

The drawings are schematic and conceptual; and the relationships between the thickness and width of portions, the proportions of sizes among portions, etc., are not necessarily the same as the actual values. The dimensions and proportions may be illustrated differently among drawings, even for identical portions.

In the specification and drawings, components similar to those described previously or illustrated in an antecedent drawing are marked with like reference numerals, and a detailed description is omitted as appropriate.

### First Embodiment

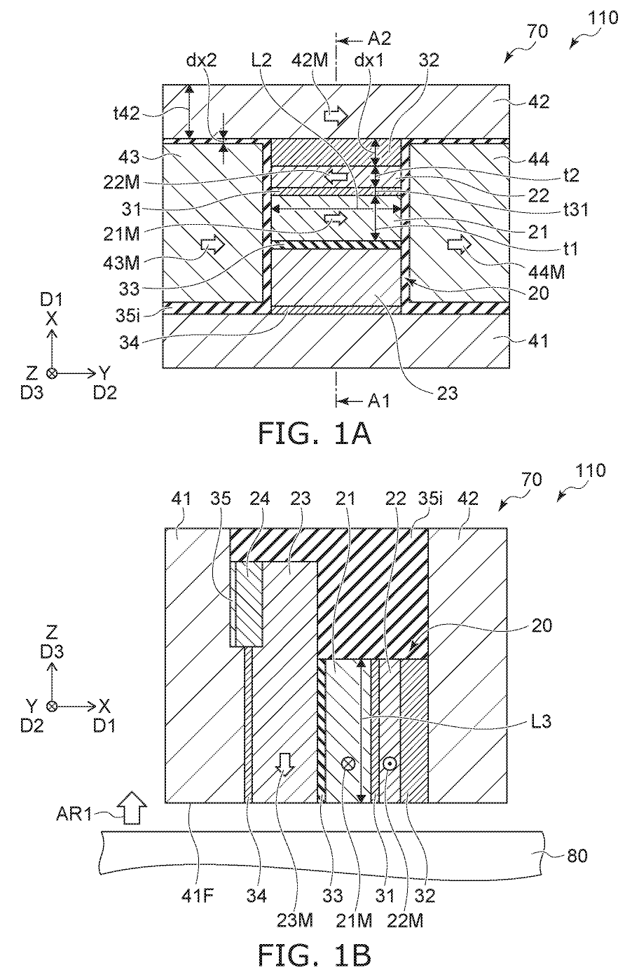

FIGS. 1A and 1B are schematic views illustrating a magnetic head according to a first embodiment.

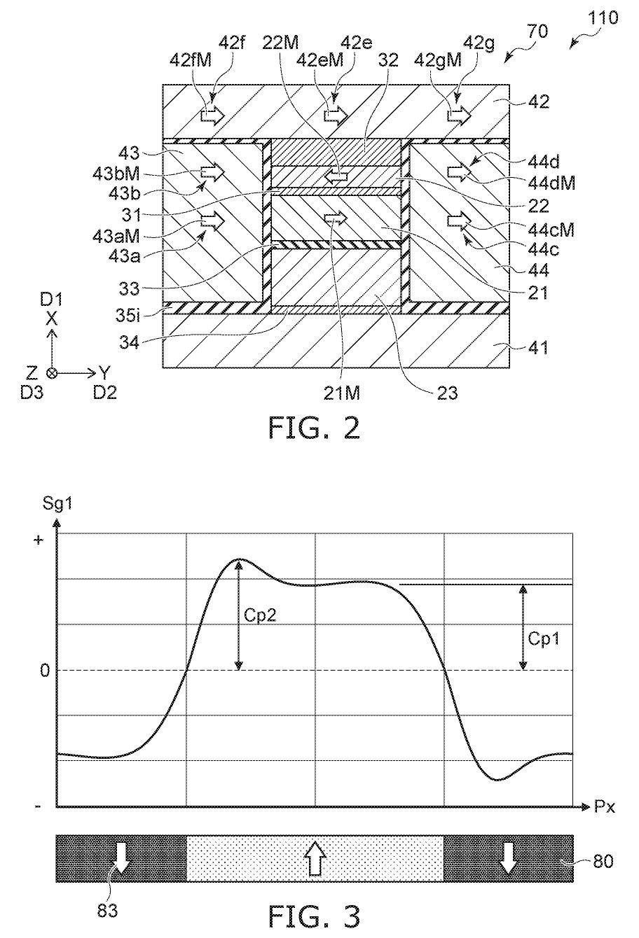

FIG. 2 is a schematic plan view illustrating the magnetic head according to the first embodiment.

FIG. 1B is a cross-sectional view taken along the line A1-A2 in FIG. 1A. FIG. 1A and 2 are plan views viewed along the arrow AR1 in FIG. 1B.

As shown in FIGS. 1A and 1B, a magnetic head 110 according to the embodiment includes a reproducing section 70. The reproducing section 70 includes a first shield 41, a second shield 42, a third shield 43, a fourth shield 44, and a stacked body 20.

The third shield 43 and the fourth shield 44 are located between the first shield 41 and the second shield 42. A second direction D2 from the third shield 43 to the fourth shield 44 crosses a first direction D1 from the first shield 41 to the second shield 42.

The first direction D1 is defined as an X-axis direction. A direction perpendicular to the X-axis direction is defined as a Y-axis direction. A direction perpendicular to the X-axis direction and the Y-axis direction is defined as a Z-axis direction. The second direction D2 may be along the Y-axis direction, for example.

As shown in FIG. 1B, the first shield 41 includes a first end 41F. The first end 41F faces a magnetic recording medium 80. The first end 41F may be, for example, at least a part of the medium facing face. For example, the first direction D1 and the second direction D2 are along the medium facing face. A direction crossing a plane including the first direction D1 and the second direction D2 is a third direction D3. The third direction D3 may be along the Z-axis direction, for example.

The X-axis direction corresponds, for example, to the down-track direction. The Y-axis direction corresponds, for example, to the cross-track direction. The Z-axis direction corresponds, for example, to the height direction.

At least a part of the stacked body 20 is provided between the first shield 41 and the second shield 42, and between the third shield 43 and the fourth shield 44. The third shield 43 and the fourth shield 44 function, for example, as side shields.

The stacked body 20 includes a first magnetic layer 21, a second magnetic layer 22, a third magnetic layer 23, a fourth magnetic layer 24 (see FIG. 1B), a first intermediate layer 31, and a second intermediate layer 32.

The first magnetic layer 21 is between the first shield 41 and the second shield 42. The second magnetic layer 22 is between the first magnetic layer 21 and the second shield 42 in the first direction D1. The third magnetic layer 23 is between the first shield 41 and the first magnetic layer 21 in the first direction D1. The fourth magnetic layer 24 overlaps at least a part of the third magnetic layer 23 in the first direction D1. The fourth magnetic layer 24 may be in contact with the third magnetic layer 23. The first intermediate layer 31 is between the first magnetic layer 21 and the second magnetic layer 22. The second intermediate layer 32 is between the second magnetic layer 22 and the second shield 42 .

The fourth magnetic layer 24 includes, for example, Mn. For example, the fourth magnetic layer 24 includes at least one selected from the group consisting of IrMn, PtMn, and IrMnCr. The fourth magnetic layer 24 is, for example, an antiferromagnetic layer.

The first magnetic layer 21 and the second magnetic layer 22 may include, for example, at least one selected from the group consisting of Fe, Co, and Ni. The first magnetic layer 21 and the second magnetic layer 22 are, for example, ferromagnetic layers.

The first intermediate layer 31 includes at least one selected from the group consisting of Ru, Ir, Os, Re, and Rh. A first intermediate layer thickness t31 in the first direction D1 of the first intermediate layer 31 is, for example, not less than 0.3 nm and not more than 0.5 nm, or not less than 0.7 nm and less than 1.0 nm.

For example, the first magnetic layer 21 is antiferromagnetically coupled to the second magnetic layer 22. For example, the magnetization 22M of the second magnetic layer 22 includes a component in an orientation opposite to an orientation of the magnetization 21M of the first magnetic layer 21. For example, the orientation of the magnetization 22M of the second magnetic layer 22 is opposite to the orientation of the magnetization 21M of the first magnetic layer 21. The first magnetic layer 21, the first intermediate layer 31, and the second magnetic layer 22 form a SAF (synthetic antiferromagnetic) structure or a SyF (synthetic ferrimagnetic) structure.

For example, the magnetization 23M (see FIG. 1B) of the third magnetic layer 23 may be substantially fixed by the fourth magnetic layer 24. The orientation of the magnetization 23M is less likely to change than the orientation of the magnetization 21M. The orientation of the magnetization 23M is less likely to change than the orientation of the magnetization 22M. The third magnetic layer 23 is, for example, a pinned layer. The first magnetic layer 21 and the second magnetic layer 22 are, for example, free layers.

The second intermediate layer 32 is non-magnetic and conductive. The second intermediate layer 32 is in contact with, for example, the second magnetic layer 22 and the second shield 42.

In the embodiment, a signal corresponding to the information (orientation of magnetization) recorded on the magnetic recording medium 80 is obtained from the stacked body 20. For example, a signal generated in the stacked body 20 is obtained via the first shield 41 and the second shield 42. For example, the magnetic recording medium 80 is a perpendicular magnetic recording medium.

For example, the magnetization 21M of the first magnetic layer 21 and the magnetization 22M of the second magnetic layer 22 change according to the orientation of the magnetic field based on the magnetization of the magnetic recording medium 80. On the other hand, the magnetization 23M of the third magnetic layer 23 is substantially fixed. The angle between the orientation of the magnetization of the pinned layer and the orientation of the magnetization of the free layer changes according to the orientation of the magnetic field based on the magnetization of the magnetic recording medium 80. Thereby, an electric signal is generated in the stacked body 20. For example, the angle between the orientation of the magnetization of the region on the free layer side of the pinned layer and the orientation of the magnetization of the region on the pinned layer side of the free layer (for example, the first magnetic layer 21) changes. Thereby, the resistance of the stacked body 20 is changed, and an electric signal is generated according to the change in resistance. The electric signal (change in resistance) may be detected by applying a current or voltage to the stacked body 20.

The electrical signal obtained from the stacked body 20 may include, for example, a signal waveform (differential waveform) obtained in response to changes in the orientation of the magnetization of the magnetic recording medium 80, and a signal waveform (long-term waveform) obtained when the orientation of the magnetization is stable. Thereby, a more accurate reproduction signal can be obtained. According to the embodiment, a magnetic head with improved characteristics can be provided.

FIG. 3 is a schematic diagram illustrating the characteristics of the magnetic head according to the first embodiment.

The horizontal axis of the graph in FIG. 3 is the position Px along the X-axis direction in the stacked body 20. FIG. 3 illustrates the directions of the magnetization 83 of the magnetic recording medium 80 facing the first magnetic layer 21 at different positions Px. The vertical axis is the signal Sg1 (electrical signal) obtained from the stacked body 20.

As shown in FIG. 3, when magnetization 83 is "upward", the signal Sg1 is high. When magnetization 83 is "downward", the signal Sg1 is low. Thus, the level of the signal Sg1 changes according to the orientation of the magnetization 83. The change in the level of the signal Sg1 according to the orientation of the magnetization 83 corresponds to, for example, a "long-term waveform."

As shown in FIG. 3, a peak occurs in the signal Sg1 according to the change of the magnetization 83 from "downward" to "upward". A bottom occurs in the signal Sg1 according to the change of the magnetization 83 from "upward" to "downward". The peak and bottom of the signal Sg1 correspond to, for example, a "differential waveform". For example, when the magnetization 83 is "upward", the signal Sg1 may be low, and when the magnetization 83 is "downward", the signal Sg1 may be high. The bottom may occur in the signal Sg1 according to the change of the magnetization 83 from "downward" to "upward", and the peak may occur in the signal Sg1 according to the change of the magnetization 83 from "upward" to "downward". The direction in which the signal appears differs depending on, for example, the orientation of the magnetization of the third magnetic layer 23.

For example, the magnetization 21M of the first magnetic layer 21 and the magnetization 22M of the second magnetic layer 22 change depending on the orientation of the magnetization 83 of the magnetic recording medium 80. It is considered that the "long-term waveform" occurs in response to these changes in the orientation of the magnetization.

On the other hand, for example, at least one of the magnetization 21M of the first magnetic layer 21 or the magnetization 22M of the second magnetic layer 22 is affected by the third shield 43 and the fourth shield 44. In one example, due to the influence of the side shields, the magnetization 22M of the second magnetic layer 22 is more easily changed than the magnetization 21M of the first magnetic layer 21. It is considered that the peak (for example, a differential waveform) of the signal Sg1 is obtained depending on the ease with which the orientation of the magnetization in these magnetic layers changes.

In this embodiment, the information recorded on the magnetic recording medium 80 is reproduced by the signal Sg1, which includes the "differential waveform" and the "long-term waveform." This allows a more accurate reproduction signal to be obtained.

As shown in FIG. 1A, the orientation of the magnetization 43M of the third shield 43 may be the same as the orientation of the magnetization 44M of fourth shield 44. The orientation of the magnetization 21M of first magnetic layer 21 has a component in the magnetization orientation of these shields. The orientation of the magnetization 22M of second magnetic layer 22 has a component in an orientation opposite to the orientation of the magnetization of these shields.

The orientation of the magnetization 42M of the second shield 42 may be the same as the orientation of the magnetization 43M of the third shield 43 and the orientation of the magnetization 44M of the fourth shield 44. The orientations of the magnetization of these shields may include, for example, a component along the second direction D2. The orientation of the magnetization 21M of the first magnetic layer 21 may include a component along the second direction D2. The orientation of the magnetization 22M of the second magnetic layer 22 may include a component in a direction opposite to the second direction D2.

As shown in FIG. 2, the third shield 43 includes a first shield region 43a and a second shield region 43b. A direction from the first shield region 43a to the first magnetic layer 21 is along the second direction D2. A direction from the second shield region 43b to the second magnetic layer 22 is along the second direction D2. A direction from the first shield region 43a to the second shield region 43b may be along the first direction D1. The boundary between these regions may be clear or unclear.

The fourth shield 44 includes a third shield region 44c and a fourth shield region 44d. A direction from the first magnetic layer 21 to the third shield region 44c is along the second direction D2. A direction from the second magnetic layer 22 to the fourth shield region 44d is along the second direction D2. A direction from the third shield region 44c to the fourth shield region 44d may be along the first direction D1. The boundary between these regions may be clear or unclear.

A first orientation of the magnetization 43aM of the first shield region 43a may be the same as a second orientation of the magnetization 43bM of the second shield region 43b. A third orientation of the magnetization 44cM of the third shield region 44c may be the same as a fourth orientation of the magnetization 44dM of the fourth shield region 44d. The first orientation may be the same as the third orientation.

As shown in FIG. 2, the second shield 42 includes a fifth shield region 42e, a sixth shield region 42f, and a seventh shield region 42g. A direction from the second magnetic layer 22 to the fifth shield region 42e is along the first direction D1. A direction from the third shield 43 to the sixth shield region 42f is along the first direction D1. A direction from the fourth shield 44 to the seventh shield region 42g is along the first direction D1. A direction from the sixth shield region 42f to the fifth shield region 42e may be along the second direction D2. A direction from the sixth shield region 42f to the seventh shield region 42g may be along the second direction D2. The boundaries between these regions may be clear or unclear.

The orientation of the magnetization at each position of the fifth shield region 42e, the sixth shield region 42f, and the seventh shield region 42g may be substantially uniform. For example, the magnetization in each of these regions has components of the same orientation in the second direction D2.

A fifth orientation of the magnetization 42eM of the fifth shield region 42e may be the same as a sixth orientation of the magnetization 42fM of the sixth shield region 42f. The fifth orientation may be the same as a seventh orientation of the magnetization 42gM of the seventh shield region 42g.

As shown in FIG. 1, the reproducing section 70 may include an insulating member 35i. A part of the insulating member 35i may be provided between the first shield 41 and the third shield 43. A part of the insulating member 35imay be provided between the first shield 41 and the fourth shield 44. A part of the insulating member 35imay be provided between the third shield 43 and the stacked body 20. A part of the insulating member 35i may be provided between the stacked body 20 and the fourth shield 44.

In the example of FIG. 1A, a part of the insulating member 35i is provided between the third shield 43 and the second shield 42, and between the fourth shield 44 and the second shield 42. In the embodiment, the second shield 42 may be continuous with the third shield 43. The second shield 42 may be continuous with the fourth shield 44. A non-magnetic conductive layer may be provided between the second shield 42 and the third shield 43. In this configuration, in a case where the magnetization of the second shield 42 is continuous with the magnetization of the third shield 43, the second shield 42 and the third shield 43 may be considered to be continuous through a non-magnetic conductive layer. A non-magnetic conductive layer may be provided between the second shield 42 and the fourth shield 44. In this configuration, in a case where the magnetization of the second shield 42 is continuous with the magnetization of the fourth shield 44, the second shield 42 and the fourth shield 44 may be considered to be continuous through a non-magnetic conductive layer.

A thickness t42 of the second shield 42 in the first direction D1 may be thicker than a first thickness t1 of the first magnetic layer 21 in the first direction D1. The thickness t42 may be thicker than the second thickness t2 of the second magnetic layer 22 in the first direction D1.

The thickness t42 may be thicker than a thickness of the stacked body 20 in the first direction D1. The thickness t42 may be thicker than a thickness of the third shield 43 in the first direction D1. The thickness t42 may be thicker than a thickness of the fourth shield 44 in the first direction D1. In FIG. 1A, in order to make the figure easier to see, the thickness t42 is drawn thin in addition to these states.

As shown in FIG. 1A, a distance in the first direction D1 between the second magnetic layer 22 and the second shield 42 is defined as a first distance dx1. The first distance dx1 may correspond to the thickness of the second intermediate layer 32 in the first direction D1. A distance in the first direction D1 between the third shield 43 and the second shield 42 is defined as a second distance dx2. The first distance dx1 is longer than the second distance dx2. By making the second distance dx2 short, for example, the magnetization 43M of the third shield 43, the magnetization 44M of the fourth shield 44, and the magnetization 42M of the second shield 42 are stabilized. The magnetizations of these shields may change to some extent in accordance with the magnetization 83 of the magnetic recording medium 80. For example, the magnetization 42M of the second shield 42 is configured to change. For example, the magnetization 42M of the second shield 42 is configured to change to some extent in accordance with the magnetization 83 of the magnetic recording medium 80. By the first distance dx1 being long, the second shield 42 easily functions as a shield.

A thickness of the fifth shield region 42e in the first direction D1 may be the same as thickness t42. A thickness of the sixth shield region 42f in the first direction D1 may be the same as thickness t42. A thickness of the seventh shield region 42g in the first direction D1 may be the same as thickness t42.

The second intermediate layer 32 includes at least one selected from the group consisting of, for example, Ta, Cu, Ru, Au, Ag, Rh, Pt, Pd, Cr, and Ir. The second intermediate layer 32 is, for example, a cap layer. The thickness of the second intermediate layer 32 (e.g., corresponding to the first distance dx1) may be, for example, not less than 1 nm and not more than 5 nm. The thickness of the second intermediate layer 32 (e.g., corresponding to the first distance dx1) may be, for example, not less than 2 nm and not more than 5 nm. The thickness of the second intermediate layer 32 (e.g., corresponding to the first distance dx1) may be, for example, not less than 3 nm and not more than 5 nm.

As shown in FIG. 1A, a length of the first magnetic layer 21 in the second direction D2 is defined as a second direction length L2. As shown in FIG. 1B, a length of the first magnetic layer 21 in the third direction D3 is defined as a third direction length L3. The third direction D3 crosses a plane including the first direction D1 and the second direction D2. The third direction D3 corresponds to, for example, the Z-axis direction. The second direction length L2 may be longer than the third direction length L3. This results in a higher SNR (signal to noise ratio), as described later.

As shown in FIG. 1A, the stacked body 20 may further include a third intermediate layer 33. The third intermediate layer 33 is provided between the third magnetic layer 23 and the first magnetic layer 21. The third intermediate layer 33 is non-magnetic. The third intermediate layer 33 is, for example, an oxide. The third intermediate layer 33 may include, for example, at least one selected from the group consisting of MgO, AlO, TiO, ZnO, InO, and SnO. In such a case, the tunnel magnetoresistance effect (TMR) is likely to occur. In another example, the third intermediate layer 33 may include at least one selected from the group consisting of Cu, Ru, Au, Ag, Zn, and Ga. In such a case, the giant magnetoresistance effect (GMR) is likely to occur.

As shown in FIG. 1A, the stacked body 20 may further include a fourth intermediate layer 34. The fourth intermediate layer 34 is provided between the first shield 41 and the third magnetic layer 23. The fourth intermediate layer 34 is non-magnetic and conductive. The fourth intermediate layer 34 may include at least one selected from the group consisting of Ta, Cu, Ru, Au, Ag, Rh, Pt, Pd, Cr, and Ir. A thickness of the fourth intermediate layer 34 may be, for example, not less than 1 nm and not more than 5 nm. The thickness of the fourth intermediate layer 34 may be, for example, not less than 2 nm and not more than 5 nm. The thickness of the fourth intermediate layer 34 may be, for example, not less than 3 nm and not more than 5 nm. Another magnetic layer may be provided at the position where the fourth intermediate layer 34 is provided. This magnetic layer may be considered as a part of the first shield 41.

As shown in FIG. 1B, the stacked body 20 may further include a fifth intermediate layer 35. The fifth intermediate layer 35 is provided between the first shield 41 and the fourth magnetic layer 24. The fifth intermediate layer 35 is non-magnetic and conductive. The fifth intermediate layer 35 may include, for example, at least one selected from the group consisting of Ta, Cu, Ru, Au, Ag, Rh, Pt, Pd, Cr, and Ir. Another magnetic layer may be provided at the position where the fifth intermediate layer 35 is provided. This magnetic layer may be considered as part of the first shield 41.

In the magnetic head 110, the fourth magnetic layer 24 may overlap the fourth intermediate layer 34 in the third direction D3. The fourth magnetic layer 24 may be separated from the fourth intermediate layer 34 in the third direction D3. The fourth magnetic layer 24 may overlap the first shield 41 in the third direction D3. The fourth magnetic layer 24 may be separated from the first shield 41 in the third direction D3. The fourth intermediate layer 34 may overlap the third magnetic layer 23 in the third direction D3. The fourth intermediate layer 34 may be separated from the third magnetic layer 23 in the third direction D3.

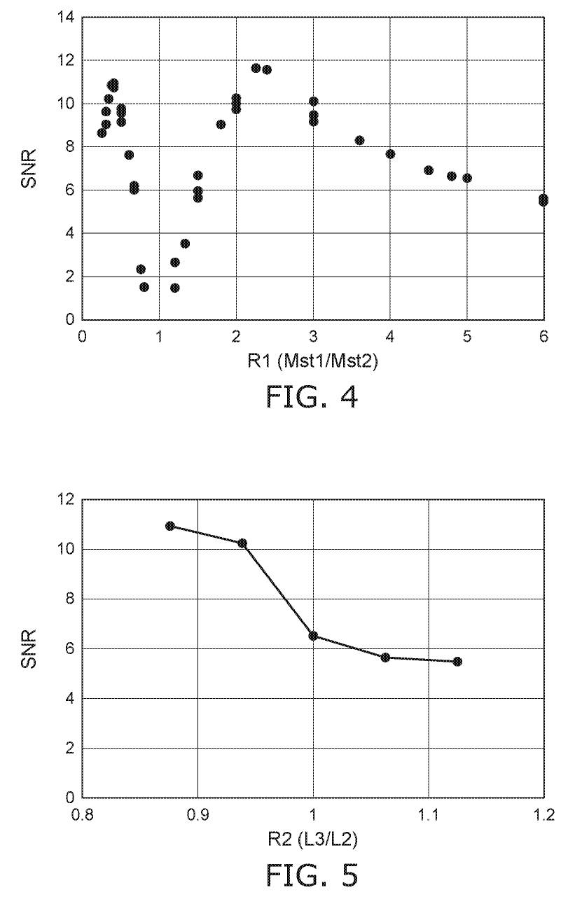

FIG. 4 is a graph illustrating the characteristics of the magnetic head according to the first embodiment.

FIG. 4 illustrates a result of a simulation of the characteristics of the magnetic head. The horizontal axis of FIG. 4 is a first ratio R1. The first ratio R1 is a ratio (Mst1/Mst2) of the first magnetic thickness Mst1 of the first magnetic layer 21 to the second magnetic thickness Mst2 of the second magnetic layer 22. The first magnetic thickness Mst1 is a product (first product) of the first thickness t1 in the first direction D1 of the first magnetic layer 21 and the first saturation magnetization of the first magnetic layer 21. The second magnetic thickness Mst2 is a product (second product) of the second thickness t2 in the first direction D1 of the second magnetic layer 22 and the second saturation magnetization of the second magnetic layer 22. The vertical axis of FIG. 4 is an SNR. In this example, the first magnetic thickness Mst1 and the second magnetic thickness Mst2 are changed. The first saturation magnetization, the second saturation magnetization, the first thickness t1, and the second thickness t2 are changed.

As shown in FIG. 4, when the first ratio R1 is close to 1, the SNR is low. When the first ratio R1 is lower than 1 or higher than 1, a high SNR is obtained.

The first ratio R1 may be, for example, not more than 0.67 or not less than 1.5. This results in a high SNR. The first ratio R1 may be not more than 0.5 or not less than 2. A further higher SNR is obtained. The first ratio R1 may be, for example, 0.2 or more. The first ratio R1 may be 6 or less. The first ratio R1 may be 4 or less.

In the embodiment, the first saturation magnetization of the first magnetic layer 21 may be the same as the second saturation magnetization of the second magnetic layer 22. In this case, the first ratio R1 corresponds to the thickness ratio (t1/t2). In the embodiment, the thickness ratio (t1/t2) of the first thickness t1 in the first direction D1 of the first magnetic layer 21 to the second thickness t2 in the first direction D1 of the second magnetic layer 22 may be not more than 0.67 or not less than 1.5. The thickness ratio may be not more than 0.5 or not less than 2. A further higher SNR is obtained. The thickness ratio may be, for example, 0.2 or more. The thickness ratio may be 6 or less. The thickness ratio may be 4 or less.

FIG. 5 is a graph illustrating the characteristics of the magnetic head according to the first embodiment.

FIG. 5 illustrates a result of a simulation of the characteristics of the magnetic head. The horizontal axis of FIG. 5 is a second ratio R2. The second ratio R2 is the ratio (L3/L2) of the third direction length L3 to the second direction length L2. As already explained, the third direction length L3 is the length of the first magnetic layer 21 in the third direction D3. The second direction length L2 is the length of the first magnetic layer 21 in the second direction D2. The vertical axis of FIG. 5 is the SNR. In this example, the first ratio R1 (Mst1/Mst2) is 2.0.

As shown in FIG. 5, a high SNR is obtained when the second ratio R2 is low. The second ratio R2 is preferably less than 1. A high SNR is obtained. The second ratio R2 may be 0.94 or less. The second ratio R2 may be 0.87 or less. A higher SNR is obtained.

In the embodiment, the length of the second intermediate layer 32 along the second direction D2 may be substantially the same as the second direction length L2. The length of the second magnetic layer 22 along the second direction D2 may be substantially the same as the second direction length L2. The length of the third magnetic layer 23 along the second direction D2 may be substantially the same as the second direction length L2.

In the embodiment, the length of the second intermediate layer 32 along the third direction D3 may be substantially the same as the third direction length L3. The length of the second magnetic layer 22 along the third direction D3 may be substantially the same as the third direction length L3.

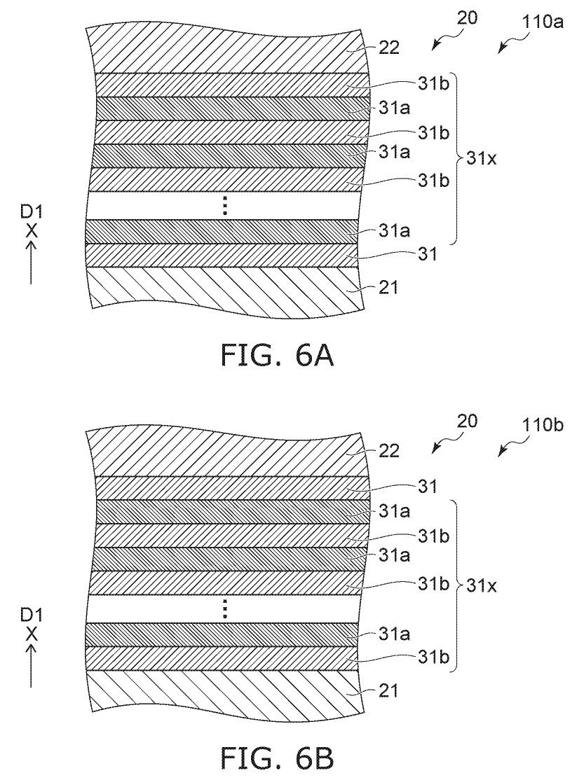

FIGS. 6A and 6B are schematic cross-sectional views illustrating a part of the magnetic head according to the first embodiment.

As shown in FIG. 6A, in a magnetic head 110a according to the embodiment, the stacked body 20 includes a stacked film 31x. Except for this, the configuration of the magnetic head 110a may be the same as the configuration of the magnetic head 110.

In the magnetic head 110a, the stacked film 31x is provided between the first intermediate layer 31 and the second magnetic layer 22. The stacked film 31x may include, for example, a plurality of first non-magnetic films 31b and a first magnetic film 31a. The first magnetic film 31a is between one of the plurality of first non-magnetic films 31b and another one of the plurality of first non-magnetic films 31b in the first direction D1. The first magnetic film 31a may be between one of the plurality of first non-magnetic films 31b and the first intermediate layer 31 in the first direction D1.

In this example, a plurality of first magnetic films 31a are provided. One of the plurality of first magnetic films 31a is between one of the plurality of first non-magnetic films 31b and another one of the plurality of first non-magnetic films 31b. One of the plurality of first magnetic films 31a may be between one of the plurality of first non-magnetic films 31b and the first intermediate layer 31. One of the plurality of first non-magnetic films 31b is between one of the plurality of first magnetic films 31a and another one of the plurality of first magnetic films 31a. One of the plurality of first non-magnetic films 31b may be between one of the plurality of first magnetic films 31a and the second shield 42.

Each of the plurality of first magnetic films 31a may include at least one selected from the group consisting of Fe, Co, and Ni. Each of the plurality of first non-magnetic films 31b may include at least one selected from the group consisting of Ru, Ir, Os, Re, and Rh. The thickness of one of the plurality of first non-magnetic films 31b in the first direction D1 may be not less than 0.3 nm and not more than 0.5 nm, or not less than 0.7 nm and less than 1.0 nm.

As shown in FIG. 6B, in a magnetic head 110b according to the embodiment, the stacked body 20 includes a stacked film 31x. The configuration of the magnetic head 110b except for this may be the same as the configuration of the magnetic head 110.

In the magnetic head 110b, the stacked film 31x is provided between the first magnetic layer 21 and the first intermediate layer 31. The configuration of the stacked film 31x in the magnetic head 110b may be the same as the configuration of the stacked film 31x in the magnetic head 110a.

In the magnetic head 110a and the magnetic head 110b, the first magnetic layer 21 is antiferromagnetically coupled to the second magnetic layer 22. In the magnetic head 110a and the magnetic head 110b, the number of first magnetic films 31a may be an even number. In the magnetic head 110a and the magnetic head 110b, the number of first non-magnetic films 31b is an even number.

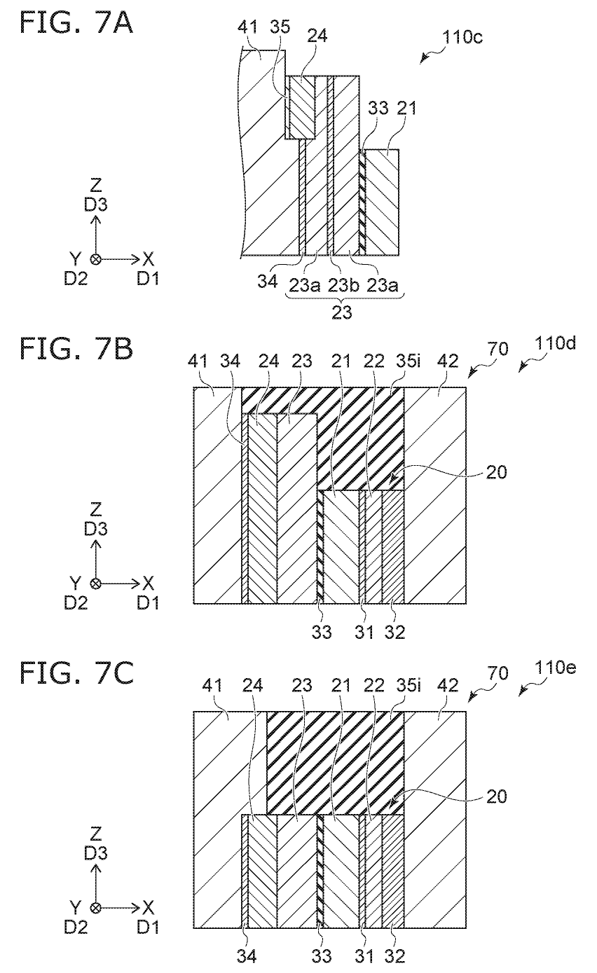

FIGS. 7A to 7C are schematic cross-sectional views illustrating a part of the magnetic head according to the first embodiment.

As shown in FIG. 7A, in a magnetic head 110c according to the embodiment, the third magnetic layer 23 includes a plurality of magnetic material films 23a and a plurality of non-magnetic material films 23b. The configuration of the magnetic head 110c except for this may be the same as the configuration of the magnetic head 110, etc.

In the magnetic head 110c, a direction from one of the plurality of magnetic material films 23a to another one of the plurality of magnetic material films 23a is along the first direction D1. One of the plurality of non-magnetic material films 23b is provided between one of the plurality of magnetic material films 23a and another one of the plurality of magnetic material films 23a.

Each of the magnetic material films 23a may include at least one selected from the group consisting of Fe, Co, and Ni. Each of the non-magnetic material films 23b may include at least one selected from the group consisting of Ru, Ir, Os, Re, and Rh. The thickness of one of the non-magnetic material films 23b in the first direction D1 may be not less than 0.3 nm and not more than 0.5 nm, or not less than 0.7 nm and less than 1.0 nm.

As shown in FIG. 7B and 7C, in a magnetic head 110d and a magnetic head 110e according to the embodiment, the stacked body 20 includes a fourth magnetic layer 24 and a fourth intermediate layer 34. The fourth magnetic layer 24 is provided between the first shield 41 and the third magnetic layer 23. The fourth intermediate layer 34 is provided between the first shield 41 and the fourth magnetic layer 24. In the magnetic head 110d, the length of the third magnetic layer 23 in the third direction D3 is longer than the length of the first magnetic layer 21 in the third direction D3. In the magnetic head 110e, the length of the third magnetic layer 23 in the third direction D3 is substantially the same as the length of the first magnetic layer 21 in the third direction D3.

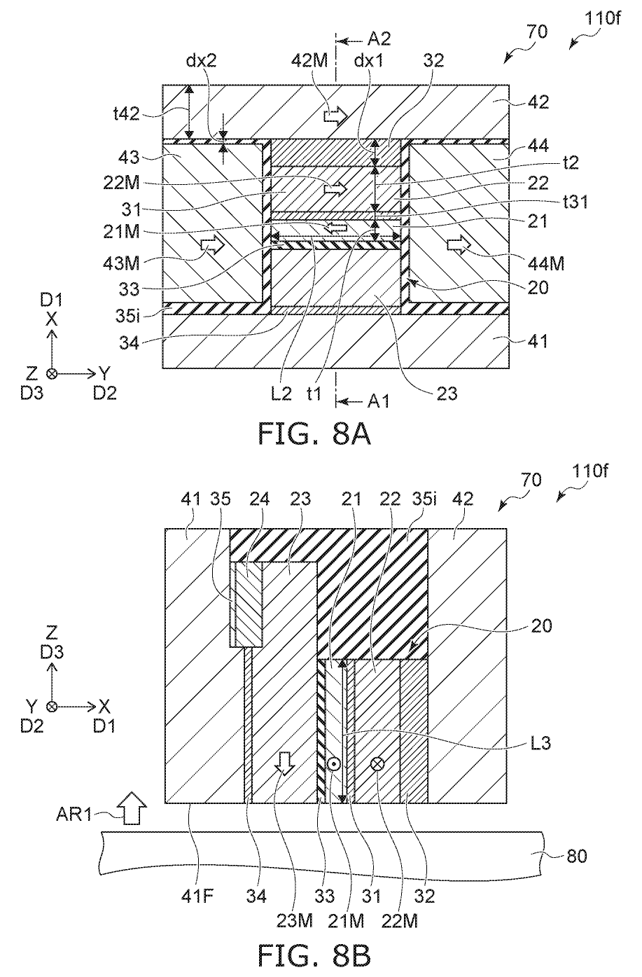

FIGS. 8A and 8B are schematic diagrams illustrating the magnetic head according to the first embodiment.

FIG. 8B is a cross-sectional view taken along the line A1-A2 in FIG. 8A. FIG. 8A is a plan view viewed along the direction of the arrow AR1 in FIG. 8B. As shown in FIGS. 8A and 8B, in a magnetic head 110f according to the embodiment, the first thickness t1 is thinner than the second thickness t2. Except for this, the configuration of the magnetic head 110f may be the same as the configuration of the magnetic head 110, etc. In the magnetic head 110f, the first ratio R1 may be, for example, 0.67 or less. The first ratio R1 may be, for example, 0.5 or less. The first ratio R1 may be, for example, 0.2 or more. The thickness ratio (t1/t2) may be, for example, 0.67 or less. The thickness ratio may be, for example, 0.5 or less. The thickness ratio may be, for example, 0.2 or more.

### Second Embodiment

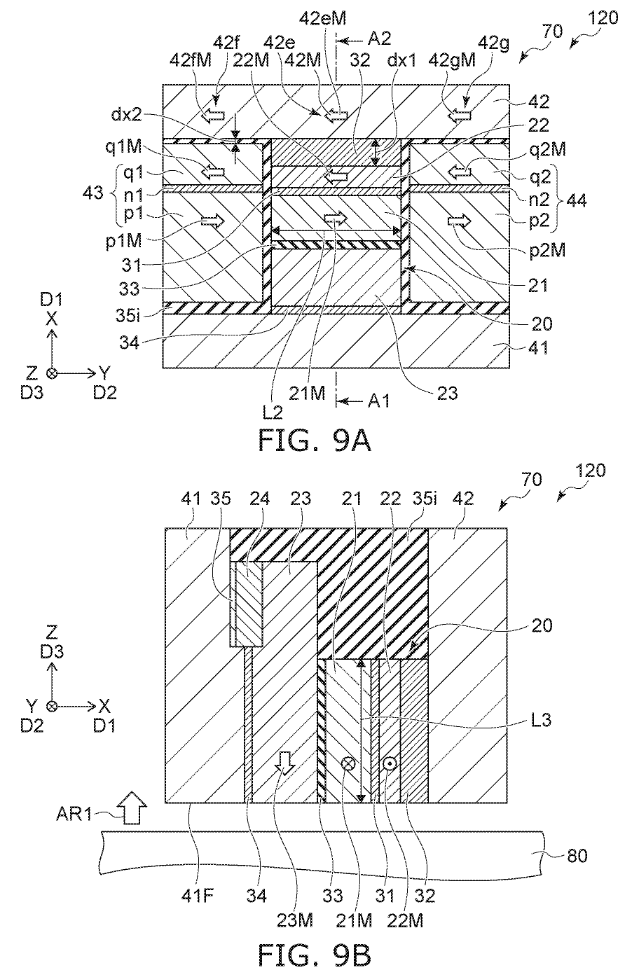

FIGS. 9A and 9B are schematic diagrams illustrating a magnetic head according to a second embodiment.

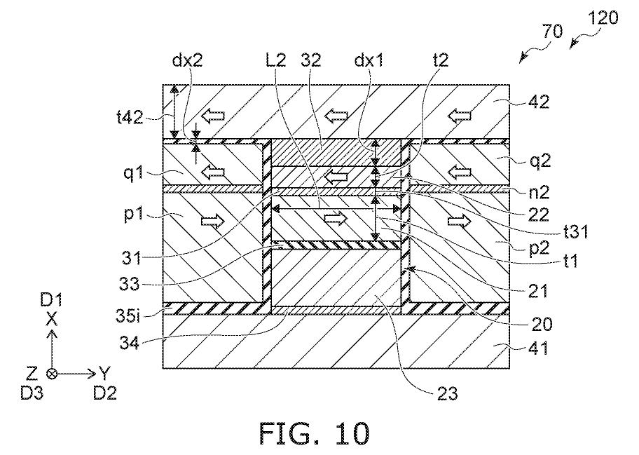

FIG. 10 is a schematic plan view illustrating the magnetic head according to the second embodiment.

FIG. 9B is a cross-sectional view taken along the line A1-A2 in FIG. 9A. FIGS. 9A and 10 are plan views viewed along the arrow AR1 in FIG. 9B.

A magnetic head 120 according to the embodiment includes a reproducing section 70. The reproducing section 70 includes the first shield 41, the second shield 42, the third shield 43, the fourth shield 44, and the stacked body 20.

The third shield 43 and the fourth shield 44 are located between the first shield 41 and the second shield 42. The second direction D2 from the third shield 43 to the fourth shield 44 crosses the first direction D1 from the first shield 41 to the second shield 42.

The third shield 43 includes a first shield portion p1, a first opposing shield portion q1, and a first shield intermediate layer n1. The first opposing shield portion q1 is between the first shield portion p1 and the second shield 42 in the first direction D1. The first shield intermediate layer n1 is between the first shield portion p1 and the first opposing shield portion q1.

The fourth shield 44 includes a second shield portion p2, a second opposing shield portion q2, and a second shield intermediate layer n2. The second opposing shield portion q2 is between the second shield portion p2 and the second shield 42 in the first direction D1. The second shield intermediate layer n2 is between the second shield portion p2 and the second opposing shield portion q2.

The stacked body 20 includes the first magnetic layer 21, the second magnetic layer 22, the third magnetic layer 23, the fourth magnetic layer 24, the first intermediate layer 31, and the second intermediate layer 32. The first magnetic layer 21 is between the first shield 41 and the second shield 42 in the first direction D1. The second magnetic layer 22 is between the first magnetic layer 21 and the second shield 42 in the first direction D1. The third magnetic layer 23 is between the first shield 41 and the first magnetic layer 21 in the first direction D1.

As shown in FIG. 9B, the fourth magnetic layer 24 overlaps at least a part of the third magnetic layer 23 in the first direction D1. The fourth magnetic layer 24 includes, for example, Mn. For example, the fourth magnetic layer 24 includes at least one selected from the group consisting of IrMn, PtMn, and IrMnCr. The fourth magnetic layer 24 is an antiferromagnetic layer. The magnetization 23M of the third magnetic layer 23 is substantially fixed by the fourth magnetic layer 24. The third magnetic layer 23 is, for example, a pinned layer.

The first intermediate layer 31 is between the first magnetic layer 21 and the second magnetic layer 22. The second intermediate layer 32 is between the second magnetic layer 22 and the second shield 42.

The first intermediate layer 31 includes at least one selected from the group consisting of Ru, Ir, Os, Re, and Rh. As shown in FIG. 10, the thickness of the first intermediate layer 31 in the first direction D1 is defined as the first intermediate layer thickness t31. The first intermediate layer thickness t31 of the first intermediate layer 31 in the first direction D1 is, for example, not less than 0.3 nm and not more than 0.5 nm, or not less than 0.7 nm and less than 1.0 nm. For example, the first magnetic layer 21 is antiferromagnetically coupled to the second magnetic layer 22. The first magnetic layer 21, the first intermediate layer 31, and the second magnetic layer 22 form an SAF structure or a SyF structure. The first magnetic layer 21 and the second magnetic layer 22 are, for example, free layers.

The second intermediate layer 32 is non-magnetic and conductive. For example, the second intermediate layer 32 contacts the second magnetic layer 22 and the second shield 42.

At least a part of the first magnetic layer 21 is between the first shield portion p1 and the second shield portion p2 in the second direction D2. At least a part of the second magnetic layer 22 is between the first opposing shield portion q1 and the second opposing shield portion q2 in the second direction D2.

For example, the ratio (Mst1/Mst2) of the first magnetic thickness Mst1 of the first magnetic layer 21 to the second magnetic thickness Mst2 of the second magnetic layer 22 is not more than 0.67, or not less than 1.5. The first magnetic thickness Mst1 is the product (first product) of the first thickness t1 of the first magnetic layer 21 in the first direction D1 and the first saturation magnetization of the first magnetic layer 21. The second magnetic thickness Mst2 is the product (second product) of the second thickness t2 of the second magnetic layer 22 in the first direction D1 and the second saturation magnetization of the second magnetic layer 22.

In the magnetic head 120, the electrical signal obtained from the stacked body 20 includes, for example, a signal waveform (differential waveform) obtained when the orientation of the magnetization of the magnetic recording medium 80 changes, and a signal waveform (long-term waveform) obtained when the orientation of the magnetization is stable. Thereby, a reproduction signal with higher accuracy can be obtained. According to the embodiment, it is possible to provide a magnetic head with improved characteristics.

In the embodiment, the above ratio (Mst1/Mst2) may be not more than 0.5, or not less than 2.

In the magnetic head 120, the first saturation magnetization of the first magnetic layer 21 may be the same as the second saturation magnetization of the second magnetic layer 22. In the magnetic head 120, the thickness ratio (t1/t2) of the first thickness t1 in the first direction D1 of the first magnetic layer 21 to the second thickness t2 in the first direction D1 of the second magnetic layer 22 may be not more than 0.67, or not less than 1.5. The thickness ratio may be not more than 0.5, or not less than 2. A further higher SNR is obtained. The thickness ratio may be, for example, 0.2 or more. The thickness ratio may be 6 or less. The thickness ratio may be 4 or less.

A first orientation of the magnetization p1M of the first shield portion p1 is the same as a second orientation of the magnetization p2M of the second shield portion p2. A first opposing orientation of the magnetization q1M of the first opposing shield portion q1 is opposite to the first orientation. A second opposing orientation of the magnetization q2M of the second opposing shield portion q2 is opposite to the second orientation. The first orientation of the magnetization p1M of the first shield portion p1 is the same as the orientation of the magnetization 21M of the first magnetic layer 21. The first opposing orientation of the magnetization q1M of the first opposing shield portion q1 is the same as the orientation of the magnetization 22M of the second magnetic layer 22.

As shown in FIG. 9A, the second shield 42 includes the fifth shield region 42e, the sixth shield region 42f, and the seventh shield region 42g. The direction from the second magnetic layer 22 to the fifth shield region 42e is along the first direction D1. The direction from the third shield 43 to the sixth shield region 42f is along the first direction D1. The direction from the fourth shield 44 to the seventh shield region 42g is along the first direction D1. The direction from the sixth shield region 42f to the fifth shield region 42e may be along the second direction D2. The direction from the sixth shield region 42f to the seventh shield region 42g may be along the second direction D2. The fifth orientation of the magnetization 42eM of the fifth shield region 42e is the same as the sixth orientation of the magnetization 42fM of the sixth shield region 42f. The fifth orientation is the same as the seventh orientation of the magnetization 42gM of the seventh shield region 42g.

In the example of FIG. 9A, a part of the insulating member 35i is provided between the third shield 43 and the second shield 42, and between the fourth shield 44 and the second shield 42. In the embodiment, the second shield 42 may be continuous with the third shield 43 (e.g., the first opposing shield portion q1). The second shield 42 may be continuous with the fourth shield 44 (e.g., the second opposing shield portion q2).

In the magnetic head 120, the configuration described in relation to the first embodiment may be applied. For example, the thickness t42 of the second shield 42 in the first direction D1 may be thicker than the first thickness t1 of the first magnetic layer 21 in the first direction D1. The thickness t42 may be thicker than the second thickness t2 of the second magnetic layer 22 in the first direction D1.

The thickness t42 may be thicker than the thickness of the stacked body 20 in the first direction D1. The thickness t42 may be thicker than the thickness of the third shield 43 in the first direction D1. The thickness t42 may be thicker than the thickness of the fourth shield 44 in the first direction D1. In FIG. 9A, in order to make the figure easier to see, the thickness t42 is drawn thin in addition to these states.

In the embodiment, the distance in the first direction D1 between the second magnetic layer 22 and the second shield 42 is defined as the first distance dx1. The distance in the first direction D1 between the third shield 43 and the second shield 42 is defined as the second distance dx2. In the magnetic head 120, the first distance dx1 may be longer than the second distance dx2. By the second distance dx2 being short, for example, the magnetization 43M of the third shield 43, the magnetization 44M of the fourth shield 44, and the magnetization 42M of the second shield 42 are stabilized. The magnetizations of these shields may change to some extent in accordance with the magnetization 83 of the magnetic recording medium 80. By the first distance dx1 being long, the second shield 42 easily functions as a shield.

The second intermediate layer 32 includes at least one selected from the group consisting of Ta, Cu, Ru, Au, Ag, Rh, Pt, Pd, Cr, and Ir. The thickness of the second intermediate layer 32 (e.g., corresponding to the first distance dx1) may be, for example, not less than 1 nm and not more than 5 nm. The thickness of the second intermediate layer 32 (e.g., corresponding to the first distance dx1) may be, for example, not less than 2 nm and not more than 5 nm. The thickness of the second intermediate layer 32 (e.g., corresponding to the first distance dx1) may be, for example, not less than 3 nm and not more than 5 nm.

The second direction length L2 in the second direction D2 of the first magnetic layer 21 may be longer than the third direction length L3 in the third direction D3 of the first magnetic layer 21. A higher SNR is obtained.

In the magnetic head 120, the stacked body 20 may further include the third intermediate layer 33. The third intermediate layer 33 is provided between the third magnetic layer 23 and the first magnetic layer 21. The third intermediate layer 33 is non-magnetic. The third intermediate layer 33 is, for example, an oxide. The third intermediate layer 33 may include, for example, at least one selected from the group consisting of MgO, AlO, TiO, ZnO, InO, and SnO. The stacked body 20 may further include the fourth intermediate layer 34. The fourth intermediate layer 34 is provided between the first shield 41 and the third magnetic layer 23. The fourth intermediate layer 34 is non-magnetic and conductive. The fourth intermediate layer 34 may include, for example, at least one selected from the group consisting of Ta, Cu, Ru, Au, Ag, Rh, Pt, Pd, Cr, and Ir. Another magnetic layer may be provided at the location where the fourth intermediate layer 34 is provided. This magnetic layer may be considered as part of the first shield 41.

The configuration described for magnetic head 110a may be applied to magnetic head 120. The configuration described for magnetic head 110b may be applied to magnetic head 120.

As already explained with reference to FIG. 3, the signal Sg1 is obtained from the stacked body 20. The signal Sg1 may be obtained by removing noise from the electrical signal obtained from the stacked body 20. For example, the electrical signal obtained a plurality of times may be averaged to obtain the signal Sg1. For example, a signal at the same position on the magnetic recording medium 80 may be obtained a plurality of times and the results may be averaged to obtain the signal Sg1. For example, signals from the same recorded information at a plurality of different positions on the magnetic recording medium 80 may be obtained a plurality of times and averaged to obtain the signal Sg1. For example, information may be recorded once on the magnetic recording medium 80, and the results of reproducing the recorded information a plurality of times may be averaged to obtain the signal Sg1. For example, recording of information and reproducing the recorded information may be repeated a plurality of times, and the obtained results may be averaged to obtain the signal Sg1.

As already described with reference to FIG. 3, for example, information recorded on the magnetic recording medium 80 is reproduced by the signal Sg1 including the "differential waveform" and the "long-term waveform". As shown in FIG. 3, the electric signal (signal Sg1) obtained from the stacked body 20 includes a first component Cp1 and a peak component Cp2. The first component Cp1 corresponds to the orientation of the magnetization 83 of the magnetic recording medium 80. The peak component Cp2 corresponds to the change in the orientation of the magnetization 83 of the magnetic recording medium 80. The first component Cp1 corresponds to the "long-term waveform". The peak component Cp2 corresponds to the "differential waveform". The magnitude of the peak component Cp2 corresponds to, for example, the maximum absolute value of the signal waveform. The magnitude of the peak component Cp2 corresponds to, for example, 1/2 the amplitude of the signal waveform. The magnitude of the first component Cp1 corresponds to, for example, a baseline shift (BLS). The BLS corresponds to the absolute value of the signal Sg1 obtained from the stacked body 20 when the orientation of the magnetization of the magnetic recording medium 80 is stable. The BLS corresponds to 1/2 the amplitude of the signal waveform (long-term waveform) obtained when the orientation of the magnetization is stable.

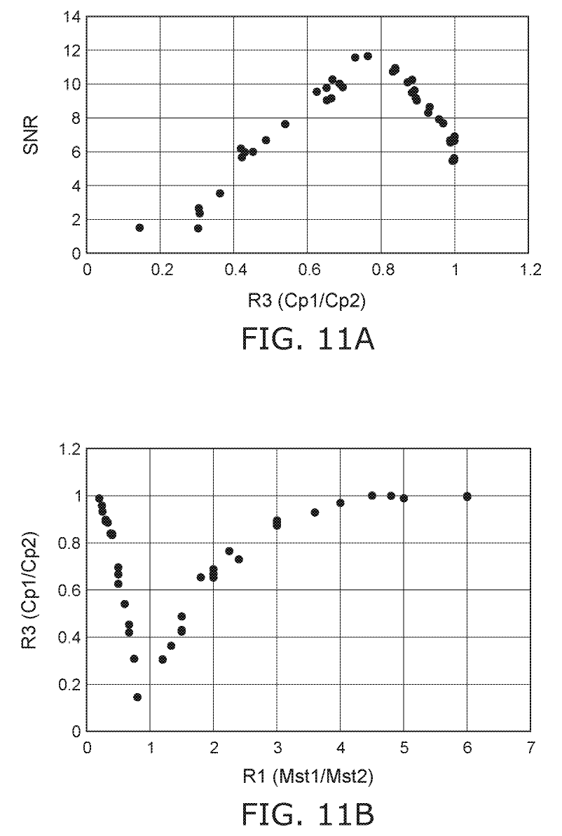

FIGS. 11A and 11B are schematic diagrams illustrating the characteristics of the magnetic head according to the first embodiment.

The horizontal axis of FIG. 11A is a third ratio R3. The third ratio R3 is a ratio of the first component Cp1 to the peak component Cp2. As shown in FIG. 3, the vertical axis of FIG. 11A is the SNR.

As shown in FIG. 11A, a high SNR can be obtained when the third ratio R3 is not less than 0.42 and not more than 0.99. It is preferable that the third ratio R3 is not less than 0.42 and not more than 0.99. It is preferable that the third ratio R3 is not less than 0.55 and not more than 0.95. A further higher SNR can be obtained. It is preferable that the third ratio R3 is not less than 0.62 and not more than 0.90. A further higher SNR can be obtained. The third ratio R3 can be controlled, for example, by controlling the first ratio R1.

The horizontal axis of FIG. 11B is the first ratio R1. As already explained, the first ratio R1 is the ratio (Mst1/Mst2) of the first magnetic thickness Mst1 of the first magnetic layer 21 to the second magnetic thickness Mst2 of the second magnetic layer 22. The vertical axis of FIG. 11B is the third ratio R3. As shown in FIG. 11B, for example, when the first ratio R1 is not less than 1.5 and not more than 4, the third ratio R3 is not less than 0.42 and not more than 0.99. In the embodiment, for example, the first ratio R1 may be not less than 1.5 and not more than 4. The first ratio R1 may be not less than 2 and not more than 3. In the embodiment, for example, the first ratio R1 may be not less than 0.2 and not more than 0.6. The first ratio R1 may be not less than 0.2 and not more than 0.53.

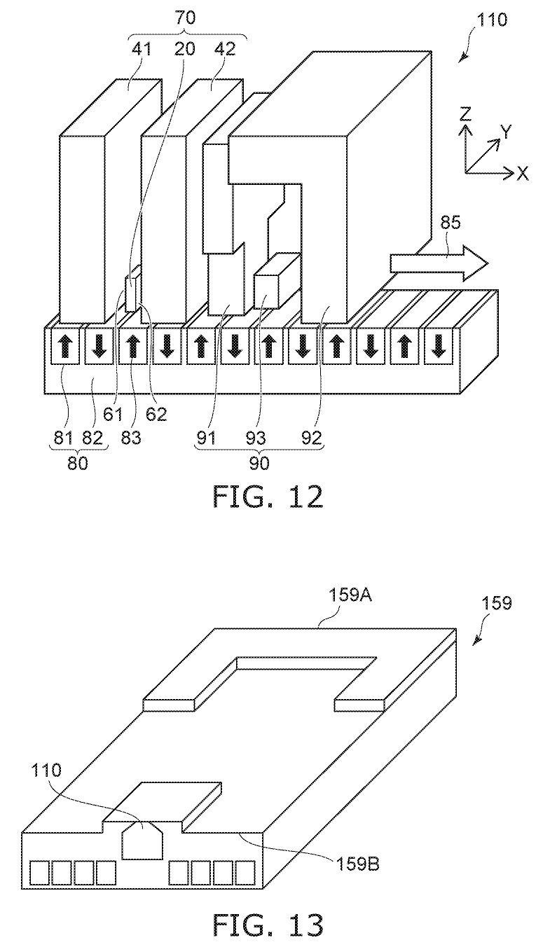

FIG. 12 is a schematic perspective view illustrating the magnetic head and magnetic recording device according to the embodiment.

As shown in FIG. 12, the magnetic head according to the embodiment (e.g., magnetic head 110) includes the reproducing section 70. The magnetic head 110 is used together with the magnetic recording medium 80. The magnetic head 110 may include a recording section 90. The recording section 90 of the magnetic head 110 records information on the magnetic recording medium 80. The reproducing section 70 reproduces the information recorded on the magnetic recording medium 80.

The magnetic recording medium 80 includes, for example, a medium substrate 82 and a magnetic recording layer 81 provided on the medium substrate 82. The magnetization 83 of the magnetic recording layer 81 is controlled by the recording section 90. The recording section 90 includes, for example, a first magnetic pole 91 and a second magnetic pole 92. The first magnetic pole 91 is, for example, a main magnetic pole. The second magnetic pole 92 is, for example, a trailing shield. The recording section 90 may include a recording section element 93. The recording section element 93 may include a magnetic field control element or a high-frequency oscillation element. The recording section element 93 may be omitted.

The reproducing section 70 includes, for example, the first shield 41, the second shield 42, and the stacked body 20. In FIG. 12, the third shield 43 and the fourth shield 44 are omitted. The reproducing section 70 can output a signal corresponding to the magnetization 83 of the magnetic recording layer 81.

As shown in FIG. 12, the magnetic recording medium 80 moves relative to the magnetic head 110 in the medium movement direction 85. The magnetic head 110 controls information corresponding to the magnetization 83 of the magnetic recording layer 81 at any position. The magnetic head 110 reproduces information corresponding to the magnetization 83 of the magnetic recording layer 81 at any position.

For example, the medium movement direction 85 is the direction from the first shield 41 to the second shield 42. For example, the magnetic recording medium 80 includes one recording area (first area). After the first area faces the first shield 41, the first area faces the second shield 42.

FIG. 13 is a schematic perspective view illustrating a part of the magnetic recording device according to the embodiment.

FIG. 13 illustrates a head slider.

The magnetic head 110 is provided on a head slider 159. The head slider 159 includes, for example, Al₂O₃/TiC. The head slider 159 moves relative to the magnetic recording medium while flying over or in contact with the magnetic recording medium.

The head slider 159 has, for example, an air inflow side 159A and an air outflow side 159B. The magnetic head 110 is arranged on the side surface of the air outflow side 159B of the head slider 159. As a result, the magnetic head 110 moves relative to the magnetic recording medium while floating above or in contact with the magnetic recording medium.

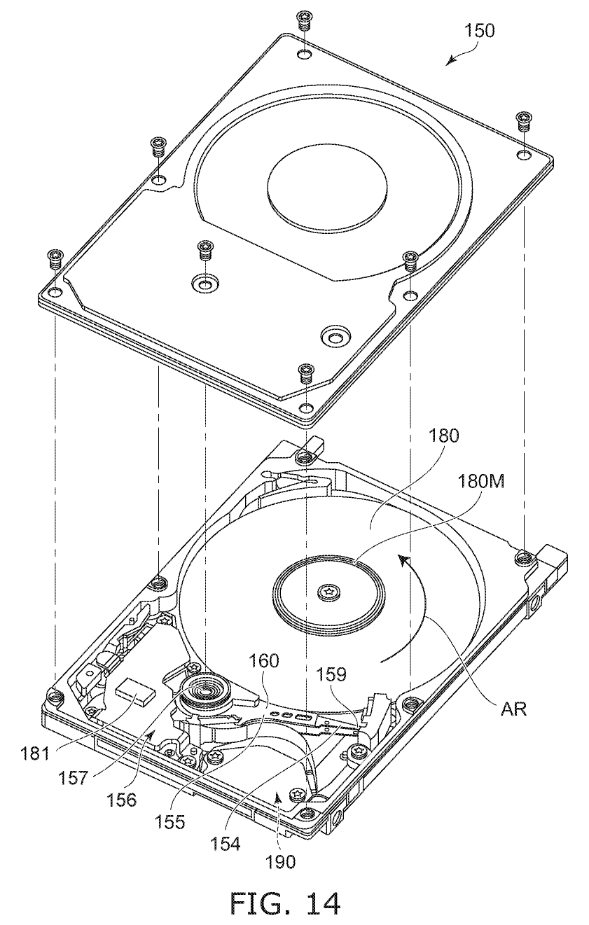

FIG. 14 is a schematic perspective view illustrating the magnetic recording device according to the embodiment.

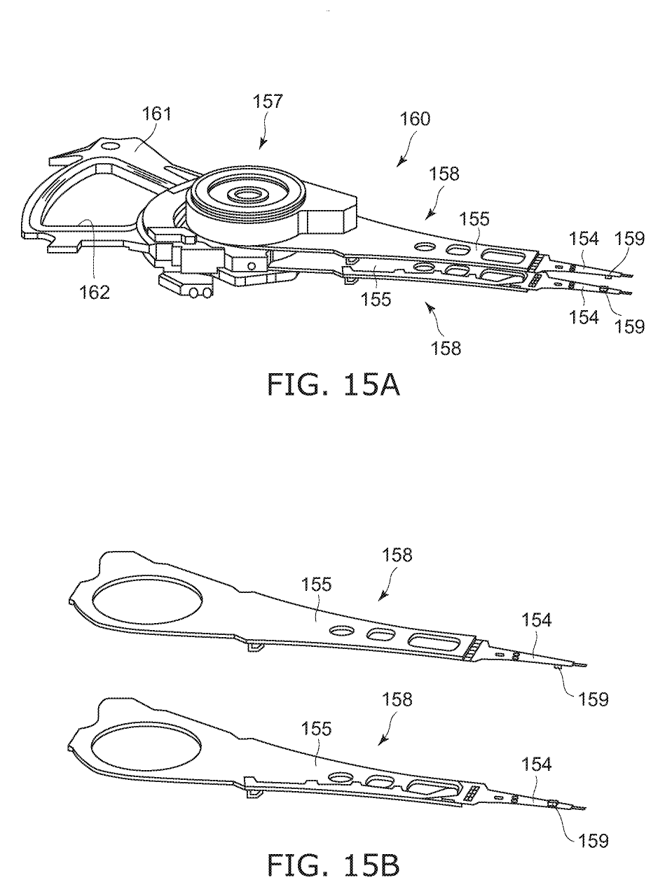

FIGS. 15A and 15B are schematic perspective views illustrating a part of the magnetic recording device according to the embodiment.

As shown in FIG. 14, in a magnetic recording device 150 according to the embodiment, a rotary actuator is used. The recording medium disk 180 is connected to a spindle motor 180M. The recording medium disk 180 is rotated in a direction of arrow AR by the spindle motor 180M. The spindle motor 180M is responsive to control signals from the drive device controller. The magnetic recording device 150 according to the embodiment may include the plurality of recording medium disks 180. The magnetic recording device 150 may include a recording medium 181. The recording medium 181 is, for example, an SSD (Solid State Drive). A non-volatile memory such as a flash memory is used for the recording medium 181, for example. For example, the magnetic recording device 150 may be a hybrid HDD (Hard Disk Drive).

The head slider 159 records and reproduces information to be recorded on the recording medium disk 180. The head slider 159 is provided at an end of a thin-film suspension 154. A magnetic head according to the embodiment is provided near the end of the head slider 159.

While the recording medium disk 180 is rotating, the pressing pressure by the suspension 154 and the floating pressure generated at the medium facing face (ABS) of the head slider 159 are balanced. The distance between the medium facing face of the head slider 159 and the surface of the recording medium disk 180 is the predetermined fly height. In the embodiment, the head slider 159 may contact the recording medium disk 180. For example, a contact sliding type may be applied.

The suspension 154 is connected to one end of an arm 155 (e.g., an actuator arm). The arm 155 includes, for example, a bobbin part or the like. The bobbin part holds a drive coil. A voice coil motor 156 is provided at the other end of the arm 155. The voice coil motor 156 is a type of linear motor. The voice coil motor 156 includes, for example, a drive coil and a magnetic circuit. The drive coil is wound on the bobbin part of the arm 155. The magnetic circuit includes permanent magnets and opposing yokes. The drive coil is provided between the permanent magnet and the opposing yoke. The suspension 154 includes one end and the other end. The magnetic head is provided at one end of the suspension 154. The arm 155 is connected to the other end of the suspension 154.

The arm 155 is held by ball bearings. Ball bearings are provided at two locations above and below a bearing part 157. The arm 155 can be rotated and slid by the voice coil motor 156. The magnetic head can move to any position on the recording medium disk 180.

FIG. 15A is an enlarged perspective view of the head stacked body assembly 160, illustrating the configuration of a part of the magnetic recording device.

FIG. 15B is a perspective view illustrating the magnetic head assembly (head gimbal assembly: HGA) 158 that forms part of the head stacked body assembly 160.

As shown in FIG. 15A, the head stacked body assembly 160 includes the bearing part 157, the magnetic head assembly 158 and a support frame 161. The magnetic head assembly 158 extends from the bearing part 157. The support frame 161 extends from the bearing part 157. A direction in which the support frame 161 extends is opposite to a direction in which the magnetic head assembly 158 extends. The support frame 161 supports a coil 162 of the voice coil motor 156.

As shown in FIG. 15B, the magnetic head assembly 158 includes the arm 155 extending from the bearing part 157 and the suspension 154 extending from the arm 155.

The head slider 159 is provided at the end of the suspension 154. The head slider 159 is provided with the magnetic head according to the embodiment.

The magnetic head assembly 158 (head gimbal assembly) according to the embodiment includes the magnetic head according to the embodiment, the head slider 159 provided with the magnetic head, the suspension 154 and the arm 155. The head slider 159 is provided at one end of the suspension 154. The arm 155 is connected to the other end of the suspension 154.

The suspension 154 may include, for example, a wiring (not shown) for recording and reproducing signals. The suspension 154 may include, for example, a heater wiring (not shown) for adjusting the fly height. The suspension 154 may include a wiring (not shown) for, for example, an oscillator element or the like. These wires may be electrically connected to a plurality of electrodes provided on the magnetic head.

A signal processor 190 is provided in the magnetic recording device 150. The signal processor 190 uses a magnetic head to record and reproduce signals on a magnetic recording medium. Input/output lines of the signal processor 190 are connected to, for example, electrode pads of the magnetic head assembly 158 and electrically connected to the magnetic head.

The magnetic recording device 150 according to the embodiment includes the magnetic recording medium, the magnetic head according to the embodiment, a movable part, a position controller, and a signal processor. The movable part separates the magnetic recording medium from the magnetic head or makes them relatively movable while they are in contact with each other. The position controller aligns the magnetic head with a predetermined recording position on the magnetic recording medium. The signal processor records and reproduces signals on the magnetic recording medium using the magnetic head.

For example, the recording medium disk 180 is used as the above magnetic recording medium. The movable part includes, for example, the head slider 159. The position controller described above includes, for example, the magnetic head assembly 158.

The embodiments may include the following Technical proposals:

### Technical Proposal 1

A magnetic head, comprising:

a reproducing section,

the reproducing section including:

a first shield,

a second shield,

a third shield,

a fourth shield, and

a stacked body,

the third shield and the fourth shield being between the first shield and the second shield,

a second direction from the third shield to the fourth shield crossing a first direction from the first shield to the second shield,

at least a part of the stacked body being provided between the first shield and the second shield and between the third shield and the fourth shield,

the stacked body including:

a first magnetic layer,

a second magnetic layer between the first magnetic layer and the second shield in the first direction,

a third magnetic layer between the first shield and the first magnetic layer in the first direction,

a fourth magnetic layer overlapping at least a part of the third magnetic layer in the first direction,

a first intermediate layer between the first magnetic layer and the second magnetic layer, and

a second intermediate layer between the second magnetic layer and the second shield,

the fourth magnetic layer including Mn,

the first intermediate layer including at least one selected from the group consisting of Ru, Ir, Os, Re and Rh, and

a first intermediate layer thickness in the first direction of the first intermediate layer being not less than 0.3 nm and not more than 0.5 nm, or not less than 0.7 nm and less than 1.0 nm,

the second intermediate layer being non-magnetic and conductive,

the second intermediate layer being in contact with the second magnetic layer and the second shield.

### Technical Proposal 2

The magnetic head according to Technical proposal 1, wherein

the third shield includes a first shield region and a second shield region,

a direction from the first shield region to the first magnetic layer is along the second direction,

a direction from the second shield region to the second magnetic layer is along the second direction,

the fourth shield includes a third shield region and a fourth shield region,

a direction from the first magnetic layer to the third shield region is along the second direction,

a direction from the second magnetic layer to the fourth shield region is along the second direction,

a first orientation of a magnetization of the first shield region is the same as the second orientation of a magnetization of the second shield region,

a third orientation of a magnetization of the third shield region is the same as a fourth orientation of a magnetization of the fourth shield region,

the first orientation is the same as the third orientation.

### Technical Proposal 3

The magnetic head according to Technical proposal 2, wherein

the second shield includes a fifth shield region, a sixth shield region, and a seventh shield region,

a direction from the second magnetic layer to the fifth shield region is along the first direction,

a direction from the third shield to the sixth shield region is along the first direction,

a direction from the fourth shield to the seventh shield region is along the first direction,

a fifth orientation of a magnetization of the fifth shield region is the same as a sixth orientation of a magnetization of the sixth shield region, and

the fifth orientation is the same as a seventh orientation of a magnetization of the seventh shield region.

### Technical Proposal 4

The magnetic head according to any one of Technical proposals 1-3, wherein

a first distance in the first direction between the second magnetic layer and the second shield is longer than a second distance in the first direction between the third shield and the second shield.

### Technical Proposal 5

The magnetic head according to any one of Technical proposals 1 to 4, wherein

a second direction length of the first magnetic layer in the second direction is longer than a third direction length of the first magnetic layer in the third direction, and

the third direction crosses a plane including the first direction and the second direction.

### Technical Proposal 6

The magnetic head according to any one of Technical proposals 1-5, wherein

a ratio of a first thickness of the first magnetic layer in the first direction to a second thickness of the second magnetic layer in the first direction is not more than 0.67, or not less than 1.5.

### Technical Proposal 7

The magnetic head according to any one of Technical proposals 1-5, wherein

a first ratio of a first magnetic thickness of the first magnetic layer to a second magnetic thickness of the second magnetic layer is not more than 0.67 or not less than 1.5,

the first magnetic thickness is a first product of a first thickness of a first magnetic layer in the first direction and a first saturation magnetization of the first magnetic layer, and

the second magnetic thickness is a second product of a second thickness of the second magnetic layer in the first direction and a second saturation magnetization of the second magnetic layer.

### Technical Proposal 8

The magnetic head according to any one of Technical proposals 1-6, wherein

the first magnetic layer is antiferromagnetically coupled to the second magnetic layer.

### Technical Proposal 9

A magnetic head, comprising:

a reproducing section,

the reproducing section including:

a first shield,

a second shield,

a third shield,

a fourth shield, and

a stacked body,

the third shield and the fourth shield being between the first shield and the second shield,

a second direction from the third shield to the fourth shield crossing a first direction from the first shield to the second shield,

the third shield including:

a first shield portion,

a first opposing shield portion between the first shield portion and the second shield in the first direction, and

a first shield intermediate layer between the first shield portion and the first opposing shield portion;

the fourth shield including:

a second shield portion,

a second opposing shield portion between the second shield portion and the second shield in the first direction, and

a second shield intermediate layer between the second shield portion and the second opposing shield portion,

the stacked body including:

a first magnetic layer,

a second magnetic layer between the first magnetic layer and the second shield in the first direction,

a third magnetic layer between the first shield and the first magnetic layer in the first direction,

a fourth magnetic layer overlapping at least a part of the third magnetic layer in the first direction,

a first intermediate layer between the first magnetic layer and the second magnetic layer, and

a second intermediate layer between the second magnetic layer and the second shield,

the fourth magnetic layer including Mn,

the first intermediate layer including at least one selected from the group consisting of Ru, Ir, Os, Re and Rh, and

a first intermediate layer thickness of the first intermediate layer in the first direction being not less than 0.3 nm and not more than 0.5 nm, or not less than 0.7 nm and less than 1.0 nm,

the second intermediate layer being non-magnetic and conductive,

the second intermediate layer being in contact with the second magnetic layer and the second shield,

at least a part of the first magnetic layer being in contact with the second magnetic layer and the second shield,

at least a part of the first magnetic layer being between the first shield portion and the second shield portion in the second direction,

at least a part of the second magnetic layer being between the first opposing shield portion and the second opposing shield portion in the second direction,

a ratio of a first magnetic thickness of the first magnetic layer to a second magnetic thickness of the second magnetic layer being not more than 0.67 or not less than 1.5,

the first magnetic thickness being a first product of a first thickness of the first magnetic layer in the first direction and a first saturation magnetization of the first magnetic layer,

the second magnetic thickness is a second product of a second thickness of the second magnetic layer in the first direction and a second saturation magnetization of the second magnetic layer.

### Technical Proposal 10

The magnetic head according to Technical proposal 9, wherein

the ratio is not more than 0.5 or not less than 2.

### Technical Proposal 11

The magnetic head according to Technical proposal 9 or 10, wherein

a first orientation of a magnetization of the first shield portion is the same as a second orientation of a magnetization of the second shield portion,

a first opposing orientation of a magnetization of the first opposing shield portion is opposite to the first orientation, and

and the second opposing direction of the magnetization of the second opposing shield portion is opposite to the second direction.

### Technical Proposal 12

The magnetic head according to Technical proposal 10, wherein

the second shield includes a fifth shield region, a sixth shield region, and a seventh shield region,

a direction from the second magnetic layer to the fifth shield region is along the first direction,

a direction from the third shield to the sixth shield region is along the first direction,

a direction from the fourth shield to the seventh shield region is along the first direction,

a fifth orientation of a magnetization of the fifth shield region is the same as a sixth orientation of a magnetization of the sixth shield region, and

the fifth direction is the same as a seventh orientation of a magnetization of the seventh shield region.

### Technical Proposal 13

The magnetic head according to any one of Technical proposals 1-5, wherein

a ratio of a first thickness of the first magnetic layer in the first direction to a second thickness of the second magnetic layer in the first direction is not more than 0.5, or not less than 2.

### Technical Proposal 14

The magnetic head according to any one of Technical proposals 1-13, wherein

a thickness of the second intermediate layer in the first direction is not less than 1 nm and not more than 5 nm.

### Technical Proposal 15

The magnetic head according to any one of Technical proposals 1-5, wherein

a thickness of the second shield in the first direction is thicker than a first thickness of the first magnetic layer in the first direction and thicker than a second thickness of the second magnetic layer in the first direction.

### Technical Proposal 16

The magnetic head according to Technical proposal 9, wherein

a thickness of the second shield in the first direction is thicker than the first thickness and thicker than the second thickness.

### Technical Proposal 17

The magnetic head according to any one of Technical proposals 1 to 16, wherein

a magnetization of the second shield is configured to change.

### Technical Proposal 18

A magnetic recording device, comprising:

the magnetic head according to Technical proposal 1 or 9; and

a magnetic recording medium,

the reproducing section being configured to reproduce information recorded on the magnetic recording medium.

### Technical Proposal 19

The magnetic recording device according to Technical proposal 18, wherein

an electrical signal obtained from the stacked body includes a first component and a peak component,

the first component depends on an orientation of a magnetization of the magnetic recording medium,

the peak component depends on a change in the orientation of the magnetization of the magnetic recording medium, and

a ratio of the first component to the peak component is not less than 0.42 and not more than 0.99.

### Technical Proposal 20

The magnetic recording device according to Technical proposal 19, wherein

a magnetization of the second shield is configured to change according to the magnetization of the magnetic recording medium.

According to the embodiment, a magnetic head and a magnetic recording device can be provided that can improve characteristics.

In the specification of the application, "perpendicular" and "parallel" refer to not only strictly perpendicular and strictly parallel but also include, for example, the fluctuation due to manufacturing processes, etc. It is sufficient to be substantially perpendicular and substantially parallel.

Hereinabove, exemplary embodiments of the invention are described with reference to specific examples. However, the embodiments of the invention are not limited to these specific examples. For example, one skilled in the art may similarly practice the invention by appropriately selecting specific configurations of components included in magnetic heads and magnetic recording devices such as shields, stacked bodies, magnetic layers, conductive members, etc., from known art. Such practice is included in the scope of the invention to the extent that similar effects thereto are obtained.

Further, any two or more components of the specific examples may be combined within the extent of technical feasibility and are included in the scope of the invention to the extent that the purport of the invention is included.

Moreover, all magnetic heads and all magnetic heads and all magnetic recording devices practicable by an appropriate design modification by one skilled in the art based on the magnetic heads and the magnetic recording devices described above as embodiments of the invention also are within the scope of the invention to the extent that the purport of the invention is included.

Various other variations and modifications can be conceived by those skilled in the art within the spirit of the invention, and it is understood that such variations and modifications are also encompassed within the scope of the invention.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the invention.

What is claimed is:

1. A magnetic head, comprising:
a reproducing section,
the reproducing section including:
a first shield,
a second shield,
a third shield,
a fourth shield, and
a stacked body,
the third shield and the fourth shield being between the first shield and the second shield,
a second direction from the third shield to the fourth shield crossing a first direction from the first shield to the second shield,
at least a part of the stacked body being provided between the first shield and the second shield and between the third shield and the fourth shield,
the stacked body including:
a first magnetic layer,
a second magnetic layer between the first magnetic layer and the second shield in the first direction,
a third magnetic layer between the first shield and the first magnetic layer in the first direction,
a fourth magnetic layer overlapping at least a part of the third magnetic layer in the first direction,
a first intermediate layer between the first magnetic layer and the second magnetic layer, and
a second intermediate layer between the second magnetic layer and the second shield,
the fourth magnetic layer including Mn,
the first intermediate layer including at least one selected from the group consisting of Ru, Ir, Os, Re and Rh, and
a first intermediate layer thickness in the first direction of the first intermediate layer being not less than 0.3 nm and not more than 0.5 nm, or not less than 0.7 nm and less than 1.0 nm,
the second intermediate layer being non-magnetic and conductive,
the second intermediate layer being in contact with the second magnetic layer and the second shield.

2. The magnetic head according to claim 1, wherein
the third shield includes a first shield region and a second shield region,
a direction from the first shield region to the first magnetic layer is along the second direction,
a direction from the second shield region to the second magnetic layer is along the second direction,
the fourth shield includes a third shield region and a fourth shield region,
a direction from the first magnetic layer to the third shield region is along the second direction,
a direction from the second magnetic layer to the fourth shield region is along the second direction,
a first orientation of a magnetization of the first shield region is the same as the second orientation of a magnetization of the second shield region,
a third orientation of a magnetization of the third shield region is the same as a fourth orientation of a magnetization of the fourth shield region,
the first orientation is the same as the third orientation.

3. The magnetic head according to claim 2, wherein
the second shield includes a fifth shield region, a sixth shield region, and a seventh shield region,
a direction from the second magnetic layer to the fifth shield region is along the first direction,
a direction from the third shield to the sixth shield region is along the first direction,
a direction from the fourth shield to the seventh shield region is along the first direction,
a fifth orientation of a magnetization of the fifth shield region is the same as a sixth orientation of a magnetization of the sixth shield region, and
the fifth orientation is the same as a seventh orientation of a magnetization of the seventh shield region.

4. The magnetic head according to claim 1, wherein
a first distance in the first direction between the second magnetic layer and the second shield is longer than a second distance in the first direction between the third shield and the second shield.

5. The magnetic head according to claim 1, wherein
a second direction length of the first magnetic layer in the second direction is longer than a third direction length of the first magnetic layer in the third direction, and
the third direction crosses a plane including the first direction and the second direction.

6. The magnetic head according to claim 1, wherein
a ratio of a first thickness of the first magnetic layer in the first direction to a second thickness of the second magnetic layer in the first direction is not more than 0.67, or not less than 1.5.

7. The magnetic head according to claim 1, wherein
a first ratio of a first magnetic thickness of the first magnetic layer to a second magnetic thickness of the second magnetic layer is not more than 0.67 or not less than 1.5,
the first magnetic thickness is a first product of a first thickness of a first magnetic layer in the first direction and a first saturation magnetization of the first magnetic layer, and
the second magnetic thickness is a second product of a second thickness of the second magnetic layer in the first direction and a second saturation magnetization of the second magnetic layer.

8. The magnetic head according to claim 1, wherein
the first magnetic layer is antiferromagnetically coupled to the second magnetic layer.

9. A magnetic head, comprising:
a reproducing section,
the reproducing section including:
a first shield,
a second shield,
a third shield,
a fourth shield, and
a stacked body,
the third shield and the fourth shield being between the first shield and the second shield,
a second direction from the third shield to the fourth shield crossing a first direction from the first shield to the second shield,
the third shield including:
a first shield portion,
a first opposing shield portion between the first shield portion and the second shield in the first direction, and
a first shield intermediate layer between the first shield portion and the first opposing shield portion;
the fourth shield including:
a second shield portion,
a second opposing shield portion between the second shield portion and the second shield in the first direction, and
a second shield intermediate layer between the second shield portion and the second opposing shield portion,
the stacked body including:
a first magnetic layer,
a second magnetic layer between the first magnetic layer and the second shield in the first direction,
a third magnetic layer between the first shield and the first magnetic layer in the first direction,
a fourth magnetic layer overlapping at least a part of the third magnetic layer in the first direction,
a first intermediate layer between the first magnetic layer and the second magnetic layer, and
a second intermediate layer between the second magnetic layer and the second shield,
the fourth magnetic layer including Mn,
the first intermediate layer including at least one selected from the group consisting of Ru, Ir, Os, Re and Rh, and
a first intermediate layer thickness of the first intermediate layer in the first direction being not less than 0.3 nm and not more than 0.5 nm, or not less than 0.7 nm and less than 1.0 nm,
the second intermediate layer being non-magnetic and conductive,
the second intermediate layer being in contact with the second magnetic layer and the second shield,
at least a part of the first magnetic layer being in contact with the second magnetic layer and the second shield,
at least a part of the first magnetic layer being between the first shield portion and the second shield portion in the second direction,
at least a part of the second magnetic layer being between the first opposing shield portion and the second opposing shield portion in the second direction,
a ratio of a first magnetic thickness of the first magnetic layer to a second magnetic thickness of the second magnetic layer being not more than 0.67 or not less than 1.5,
the first magnetic thickness being a first product of a first thickness of the first magnetic layer in the first direction and a first saturation magnetization of the first magnetic layer,
the second magnetic thickness is a second product of a second thickness of the second magnetic layer in the first direction and a second saturation magnetization of the second magnetic layer.

10. The magnetic head according to claim 9, wherein
the ratio is not more than 0.5 or not less than 2.

11. The magnetic head according to claim 9, wherein
a first orientation of a magnetization of the first shield portion is the same as a second orientation of a magnetization of the second shield portion,
a first opposing orientation of a magnetization of the first opposing shield portion is opposite to the first orientation, and
and the second opposing direction of the magnetization of the second opposing shield portion is opposite to the second direction.

12. The magnetic head according to claim 10, wherein
the second shield includes a fifth shield region, a sixth shield region, and a seventh shield region,
a direction from the second magnetic layer to the fifth shield region is along the first direction,
a direction from the third shield to the sixth shield region is along the first direction,
a direction from the fourth shield to the seventh shield region is along the first direction,
a fifth orientation of a magnetization of the fifth shield region is the same as a sixth orientation of a magnetization of the sixth shield region, and
the fifth direction is the same as a seventh orientation of a magnetization of the seventh shield region.

13. The magnetic head according to claim 1, wherein
a ratio of a first thickness of the first magnetic layer in the first direction to a second thickness of the second magnetic layer in the first direction is not more than 0.5, or not less than 2.

14. The magnetic head according to claim 1, wherein
a thickness of the second intermediate layer in the first direction is not less than 1 nm and not more than 5 nm.

15. The magnetic head according to claim 1, wherein
a thickness of the second shield in the first direction is thicker than a first thickness of the first magnetic layer in the first direction and thicker than a second thickness of the second magnetic layer in the first direction.

16. The magnetic head according to claim 9, wherein
a thickness of the second shield in the first direction is thicker than the first thickness and thicker than the second thickness.

17. The magnetic head according to claim 1, wherein
a magnetization of the second shield is configured to change.

18. A magnetic recording device, comprising:
the magnetic head according to claim 1; and
a magnetic recording medium,
the reproducing section being configured to reproduce information recorded on the magnetic recording medium.

19. The magnetic recording device according to claim 18, wherein
an electrical signal obtained from the stacked body includes a first component and a peak component,
the first component depends on an orientation of a magnetization of the magnetic recording medium,
the peak component depends on a change in the orientation of the magnetization of the magnetic recording medium, and
a ratio of the first component to the peak component is not less than 0.42 and not more than 0.99.

20. The magnetic recording device according to claim 19, wherein
a magnetization of the second shield is configured to change according to the magnetization of the magnetic recording medium.
